(19) United States
(12) Patent Application Publication
(10) Pub. No.: US 2007/0030387 A1
(43) Pub. Date: Feb. 8, 2007

(54) Audio/video device which controls synchronization of analog video and audio signal using time information

(75) Inventor: Ki-suk Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/366,505

(22) Filed: Mar. 3, 2006

(30) Foreign Application Priority Data
Jul. 22, 2005 (JP) 2005-0066746

(51) Int. Cl. H04N 5/04; H04N 9/44; H04N 9/475

(52) U.S. Cl. 348/515

(57) ABSTRACT

An audio/video device, which controls the synchronization of analog video and audio signals using time information, and a method of controlling the synchronization are provided. The audio/video device comprises a reference clock generation unit that generates and outputs a reference clock having a predetermined period of time. A signal processing unit records the time information corresponding to the reference clock onto a predetermined region of the digital video data and digital audio data in order of receiving the digital video data and digital audio data which have been decoded, and performs various signal processes to output a signal processed video signal and audio signal. A memory stores the digital video data and digital audio data recorded with the time information. Accordingly, the same time information is recorded for the video data and its corresponding audio data, so that the synchronization of the analog video signal and audio signal are controlled exactly.

### CROSS-REFERENCE TO RELATED APPLICATIONS

This application claims the benefit under 35 U.S.C. § 119 (a) of Korean Patent Application No. 2005-66746, filed on Jul. 22, 2005, the entire disclosure of which is hereby incorporated by reference.

### BACKGROUND OF THE INVENTION

1. Field of the Invention

The present invention relates to an audio/video device which controls synchronization of analog video and audio signal. More particularly, the present invention relates to an audio/video device which controls synchronization of analog video and audio signal using time information, and a method of controlling the synchronization.

2. Description of the Related Art

In recent years, many audio/video devices, such as high-definition television, have become available to the general public.

FIG. 1 is a block diagram illustrating an internal configuration of a related audio/video device. Referring to FIG. 1, an audio/video device 100 includes a video decoder 10, audio decoder 20, signal processing unit 30, memory 40, video amplification unit 50, audio amplification unit 60, display unit 70, and speaker 80.

The video decoder 10 and the audio decoder 20 decode an analog video signal and analog audio signal received from outside the audio/video device 100, respectively, in order to generate a digital video signal and digital audio signal, and then provide the generated signals to the signal processing unit 30.

The signal processing unit 30 performs various signal processing on the digital video signal and digital audio signal received from the video decoder 10 and audio decoder 20 in order to output an analog video signal and audio signal. The memory 40 stores the video signal and audio signal by the control of the signal processing unit 30.

The video amplification unit 50 amplifies and outputs the video signal received from the signal processing unit 30, and the display unit 70 receives the video signal output from the video amplification unit 50 to display on a screen.

The audio amplification unit 60 amplifies and outputs the audio signal received from the signal processing unit 30 at a predetermined level, and the speaker 80 outputs audio signals amplified by the audio amplification unit 60 for a viewer to listen to sound.

Such audio/video devices in the related art utilize a large amount of memory for improving an image quality of a video signal. Although the video signal and audio signal are simultaneously input to the signal processing unit, the memory capacity required for processing the video signal is larger than the memory capacity required for processing the audio signal. Furthermore, the output timing of the video signal and audio signal for signal processing in the signal processing unit may be different from each other.

In order to compensate for the difference in the output timing of the video signal and audio signal, the audio/video device in the related art is provided with a manual adjustment menu for adjusting a synchronization of the video signal and audio signal. However, when manually adjusting the synchronization of the video signal and audio signal, the adjustment may not be exact. As a result, the synchronization control of the video signal and audio signal through the manual adjustment menu may not be exactly correct in detail.

### SUMMARY OF THE INVENTION

An aspect of embodiments of the present invention is to address at least the above problems and/or disadvantages and to provide at least the advantages described below. Accordingly, an aspect of embodiments of the present invention is to provide an audio/video device which controls the synchronization of analog video and audio signals using time information for exactly controlling the synchronization of the video signal and audio signal using time information, and a method of controlling the synchronization.

In order to achieve the above object, it is preferable that an audio/video device which controls the synchronization of analog video and audio signals using time information according to an exemplary embodiment of the present invention includes a reference clock generation unit for generating and outputting a reference clock having a predetermined period of time. A signal processing unit records the time information corresponding to the reference clock onto a predetermined region of digital video data and digital audio data in order of receiving the digital video data and digital audio data, which have been decoded, and performs various signal processing in order to output a signal processed video signal and audio signal. A memory stores the digital video data and digital audio data recorded with time information.

It is preferable that the signal processing unit outputs the video signal and audio signal having the same time information, simultaneously, in order to control the synchronization of the analog video and audio when the signal processing is complete.

It is preferable that the same time information is recorded onto a predetermined region of digital video data and a predetermined region of digital audio data corresponding to the digital video data in accordance with the digital video data.

It is preferable that a unit of recording the time information includes at least one of a field and frame.

It is preferable that the audio/video device further includes a video and audio decoder for decoding the analog video signal and analog audio signal received from outside the audio/video device, respectively, in order to generate digital video data and digital audio data and provide the generated data to the signal processing unit.

It is preferable that the audio/video device further includes a video amplification unit for amplifying and outputting the video signal output from the signal processing unit after signal processing, and an audio amplification unit for amplifying and outputting, at a predetermined level, the audio signal output from the signal processing unit after signal processing.

It is preferable that a method of controlling synchronization of the analog video and audio signals using time information, according to an exemplary embodiment of the present invention, includes decoding an analog video signal and analog audio signal received from outside an audio/video device in order to generate digital video data and digital audio data. Time information is recorded onto a predetermined region of the digital video data and digital audio data, and the digital video data and digital audio data recorded with time information is stored. The stored digital video data and digital audio data are read in order to perform a signal process and the signal processed video signal and audio signal is output.

It is preferable that, when the signal processing is complete, the video signal and audio signal having the same time information is simultaneously output in accordance with the time information in order to control the synchronization of the analog video and audio.

It is preferable that the same time information is recorded onto a predetermined region of the digital video data and a predetermined region of the digital audio data corresponding to the digital video data.

It is preferable that a unit of recording the time information is at least one of a field and frame.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a block diagram illustrating an internal configuration of an audio/video device in the related art;

FIG. 2 is a block diagram illustrating an internal configuration of an audio/video device which controls the synchronization of analog video and audio signals using time information according to an exemplary embodiment of the present invention; and

FIG. 3 is a flow chart provided for describing a method which controls the synchronization of analog video and audio signals using time information according to an exemplary embodiment of the present invention.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

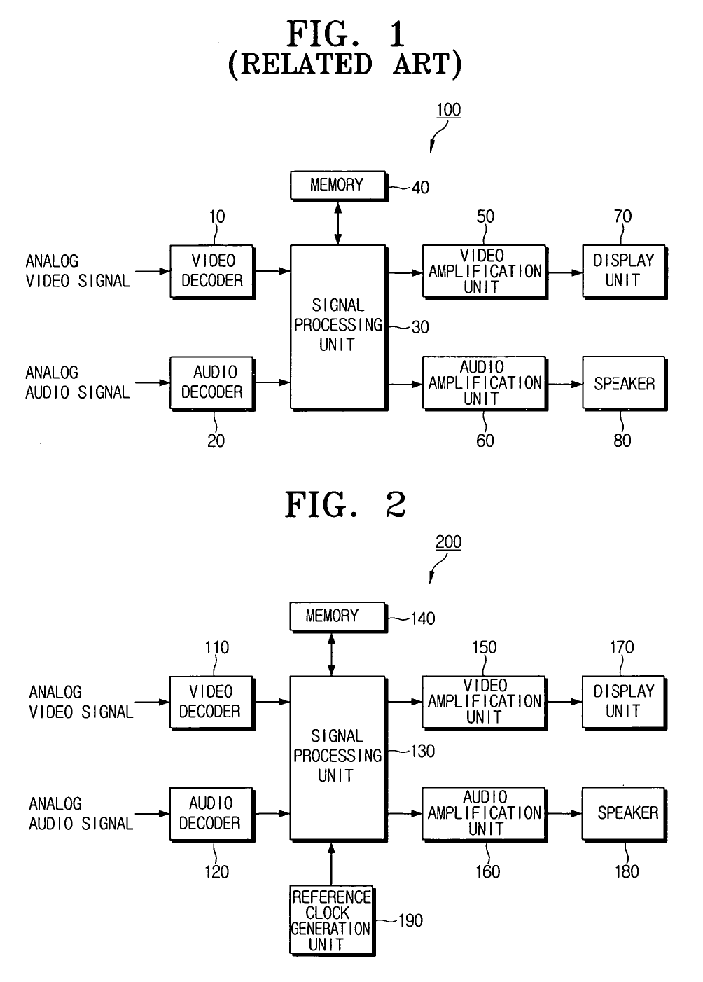

FIG. 2 is a block diagram illustrating an internal configuration of an audio/video device which controls the synchronization of analog video and audio signals using time information according to an exemplary embodiment of the present invention. Referring to FIG. 2, an audio/video device 200 of the invention includes a video decoder 110, audio decoder 120, signal processing unit 130, reference clock generation unit 190, memory 140, video amplification unit 150, audio amplification unit 160, display unit 170, and speaker 180.

The video decoder 110 and the audio decoder 120 decode an analog video signal and analog audio signal received from outside the audio/video device, respectively, in order to generate digital video data and digital audio data, and then provide the generated data to the signal processing unit 130.

The reference clock generation unit 190 generates a system reference clock having a predetermined period of time in real time, and provides the time to the signal processing unit 130. In FIG. 2, the reference clock generation unit 190 is illustrated as a separate element from the signal processing unit 130. However, the reference clock generation unit 190 can be included in the signal processing unit 130.

The signal processing unit 130, using the reference clock generated in the reference clock generation unit 190, records the time information corresponding to the reference clock onto a predetermined region of digital video data and its corresponding digital audio data. The signal processing unit 130 also stores the digital video data and its corresponding digital audio data recorded with time information in the memory 140.

Furthermore, the signal processing unit 130 performs a signal process, and then outputs video data and its corresponding audio data according to the time information of the video data. At this time, the video data and its corresponding audio data is encoded in the signal processing unit 130 and output in analog form.

The video amplification unit 150 amplifies and outputs video data received from the signal processing unit 130. The display unit 170 receives video signals output from the video amplification unit 150 to display on a screen.

The audio amplification unit 160 amplifies and outputs audio data received from the signal processing unit 130 at a predetermined level, and the speaker 180 outputs audio signals amplified by the audio amplification unit 160 for a viewer to listen to sound.

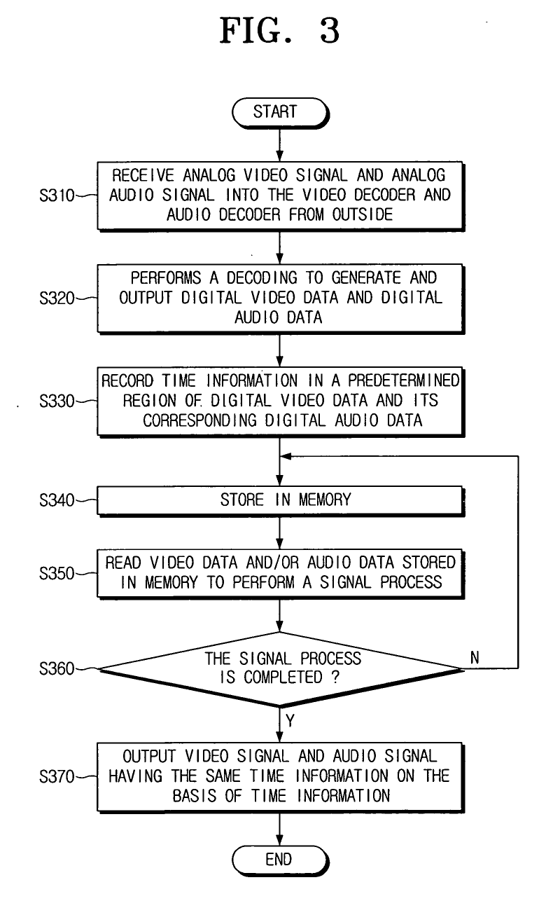

FIG. 3 is a flow chart provided for describing a method which controls the synchronization of analog video and audio signals using time information according to an exemplary embodiment of the present invention. Referring to FIG. 2 and FIG. 3, an analog video signal and analog audio signal are first input, respectively, from outside the audio/video device 100 to the video decoder 110 and the audio decoder 120 (S310).

The video decoder 110 decodes the analog video signal received from outside the audio/video device 100 in order to generate digital video data, and provide the generated digital video data to the signal processing unit 130 (S320). Likewise, the audio decoder 120 decodes the analog audio signal received from outside the audio/video device 100 in order to generate digital audio data, and provide the generated digital audio data to the signal processing unit 130 (S320).

The reference clock generation unit 190 generates a system reference clock having a predetermined period of time in real time to provide the time to the signal processing unit 130. In FIG. 2, the reference clock generation unit 190 is illustrated as a separate element from the signal processing unit 130. However, the reference clock generation unit 190 can be included in the signal processing unit 130.

The signal processing unit 130 receives digital video data from the video decoder 110, and the digital audio data corresponding to the digital video data from the audio decoder 120.

Subsequently, the signal processing unit 130, using the reference clock generated from the reference clock generation unit 190, records the time information corresponding to the reference clock onto a predetermined region of digital video data and its corresponding digital audio data (S330).

The time information recorded onto digital video data and its corresponding digital audio data will be determined by the order of data being input into the signal processing unit 130. For example, time information ‘1’ is recorded in the predetermined region of the digital video data received first and its corresponding digital audio data. Time information is recorded in the order of ‘2’, ‘3’, . . . , and so on, in the predetermined region of the digital video data sequentially received subsequently and its corresponding digital audio data.

Furthermore, since a unit of recording time information is based on digital video data, the unit of recording time information includes a frame or field. Whether the unit of recording time information includes a frame or field will be determined by a video storing method of the audio/video device. Typically, for audio/video devices using an interlaced scanning method, the video information is recorded into a storage medium in a field unit in case the video information is a fast moving video, or in a frame unit in case the video information is a slow moving video. For that reason, when the video is stored in a field unit, the unit of recording time information will be a field unit. When the video is stored in a frame unit, the unit of recording time information will be a frame unit.

When the time information, corresponding to the reference clock, is stored in the predetermined region of digital video data and its corresponding digital audio data, the signal processing unit 130 stores the digital video data and its corresponding digital audio data recorded with the same time information into the memory 140 (S340).

Subsequently, the signal processing unit 130, when required for signal processing, reads the digital video data and/or digital audio data stored in the memory 140 in order to perform a signal process, and stores the result in the memory 140 again (S350).

In other words, the signal processing unit 130 can store in the memory 140 video data and/or audio data repeatedly for various signal processes, or read video data and/or audio data from the memory 140 repeatedly. When video data and/or audio data is received or transmitted between the memory 140 and the signal processing unit 130, the time information recorded in the video data and its corresponding audio data will be maintained in its existing state.

When the signal process is complete, the signal processing unit 130 outputs the video signal and its corresponding audio signal, having the same time information in accordance with the recorded time information. At this time, the video signal and audio signal output from the signal processing unit 130 will be output as a digital signal or analog signal according to the type of display device, that is, the display unit 170.

In other words, since the time information with a smaller value is input earlier to the signal processing unit 130, the signal processing unit 130 outputs the video signal and audio signal having a smaller value of time information to the video amplification unit 150 and the audio amplification unit 160, respectively (S370).

Subsequently, the video amplification unit 150 amplifies and outputs the video signal received from the signal processing unit 130, and the display unit 170 receives the video signal output from the video amplification unit 150 in order to display on a screen.

The audio amplification unit 160 amplifies and outputs the audio signal received from the signal processing unit 130 at a predetermined level, and the speaker 180 outputs the audio signal amplified by the audio amplification unit 160 for a viewer to listen to sound.

As describe above, according to exemplary embodiments of the present invention, the same time information is recorded for video data. By recording the same time information, the synchronization of an analog video signal and audio signal is exactly controlled.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An audio and video device comprising:
a reference clock generation unit for generating and outputting a reference clock comprising a period of time;
a signal processing unit for recording the time information corresponding to the reference clock onto a region of the digital video data and digital audio data in order of receiving decoded digital video data and digital audio data, and performing various signal processes in order to output a signal processed video signal and audio signal; and
a memory for storing the digital video data and digital audio data recorded with time information.

2. The audio and video device according to claim 1, wherein the signal processing unit outputs substantially simultaneously the video signal and audio signal comprising the same time information to control the synchronization of analog video and audio when the signal processing is complete.

3. The audio and video device according to claim 1, wherein the same time information is recorded onto a region of the digital video data and a region of the digital audio data corresponding to the digital video data.

4. The audio and video device according to claim 3, wherein the recording of the time information is recorded in a unit of at least one of a field and frame.

5. The audio and video device according to claim 1, further comprising:
a video and audio decoder for decoding the analog video signal and analog audio signal received from outside the audio and video device, respectively, in order to generate the decoded digital video data and digital audio data and provide the generated data to the signal processing unit.

6. The audio and video device according to claim 1, further comprising:
a video amplification unit for amplifying and outputting the video signal output from the signal processing unit after the signal processing; and
an audio amplification unit for amplifying and outputting at a level the audio signal output from the signal processing unit after the signal processing.

7. A method of controlling synchronization comprising:
decoding an analog video signal and analog audio signal received from outside an audio and video device in order to generate digital video data and digital audio data;
recording time information onto a region of the digital video data and digital audio data, and storing the digital video data and digital audio data recorded with time information; and
reading the stored digital video data and digital audio data to perform a signal process and outputting a signal processed video signal and audio signal.

8. The method of controlling synchronization according to claim 7, further comprising outputting substantially simultaneously the video signal and audio signal comprising the same time information, in accordance with the recorded the time information, in order to control the synchronization of the analog video and audio signal, when the signal processing is completed.

9. The method of controlling synchronization according to claim 7, wherein the same time information is recorded onto a region of the digital video data and a region of the digital audio data corresponding to the digital video data.

10. The method of controlling synchronization according to claim 7, wherein the recording of the time information is recorded in a unit of at least one of a field and frame.
